(19) United States
(12) Patent Application Publication
(10) Pub. No.: US 2006/0231350 A1
(43) Pub. Date: Oct. 19, 2006

(54) Elevator

(76) Inventor: Naoki Hashiguchi, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/567,034

(22) PCT Filed: Jul. 12, 2004
(86) PCT No.: PCT/JP04/09917

§ 371 Date: Feb. 3, 2006

(51) Int. Cl. B66B 11/02

(52) U.S. Cl. 187/401

(57) ABSTRACT

In an elevator apparatus, a car that is raised and lowered within a hoistway has a car frame and a cage supported on the car frame. Chamfered portions are provided at corner portions of the cage. The car frame has vertical columns arranged along the chamfered portions.

### TECHNICAL FIELD

The present invention relates to an elevator apparatus in which an elevator car having a car frame and a cage supported on the car frame is raised and lowered within a hoistway. Background Art

In a conventional elevator apparatus, a car guide rail is disposed in a space between a car and a wall of a hoistway. Further, a counterweight is disposed in a space behind the car guide rail within the hoistway. Moreover, a hoisting machine is disposed in a space in front of the car guide rail within the hoistway. (For example, see Patent Document 1)

Patent Document 1: JP 09-165163 A

### DISCLOSURE OF THE INVENTION

### Problem to be Solved by the Invention

In the conventional elevator apparatus, however, a space for disposing the car guide rail between the car and the wall of the hoistway needs to be secured. This entails an increase in the space for the hoistway.

The present invention is made to solve the problem as mentioned above, and has an object of providing an elevator apparatus enabling a further reduction in the space for a hoistway.

### Means for Solving the Problem

An elevator apparatus according to the present invention includes a car raised and lowered within a hoistway, the car having a car frame and a cage supported on the car frame, in which the cage has a chamfered portion provided at a corner portion thereof, and in which the car frame has a vertical column arranged along the chamfered portion.

An elevator apparatus according to the present invention includes a car raised and lowered within a hoistway, the car having a car frame including a vertical column and a cage supported on the car frame, in which the cage has a recess provided in a side face thereof and the vertical column is at least partially disposed within the recess.

### BRIEF DESCRIPTION OF THE DRAWINGS

FIG. 1 is a plan view showing an elevator apparatus according to Embodiment 1 of the present invention.

FIG. 2 is a side view showing the elevator apparatus shown in FIG. 1.

FIG. 3 is a perspective view showing a car shown in FIG. 1.

FIG. 4 is an enlarged main-portion plan view of FIG. 1.

FIG. 5 is a plan view showing a safety device of the elevator apparatus shown in FIG. 1.

FIG. 6 is a plan view showing an elevator apparatus according to Embodiment 2 of the present invention.

FIG. 7 is a plan view showing an elevator apparatus according to Embodiment 3 of the present invention.

FIG. 8 is a perspective view showing a car shown in FIG. 7.

FIG. 9 is a main-portion sectional view showing the car shown in FIG. 7.

FIG. 10 is a perspective view showing an elevator apparatus according to Embodiment 4 of the present invention.

FIG. 11 is an explanatory diagram schematically showing the structure of a car frame shown in FIG. 10.

FIG. 12 is a plan view showing an elevator apparatus according to Embodiment 5 of the present invention.

### BEST MODE FOR CARRYING OUT THE INVENTION

Hereinbelow, preferred embodiments of the present invention will be described with reference to the drawings.

### Embodiment 1

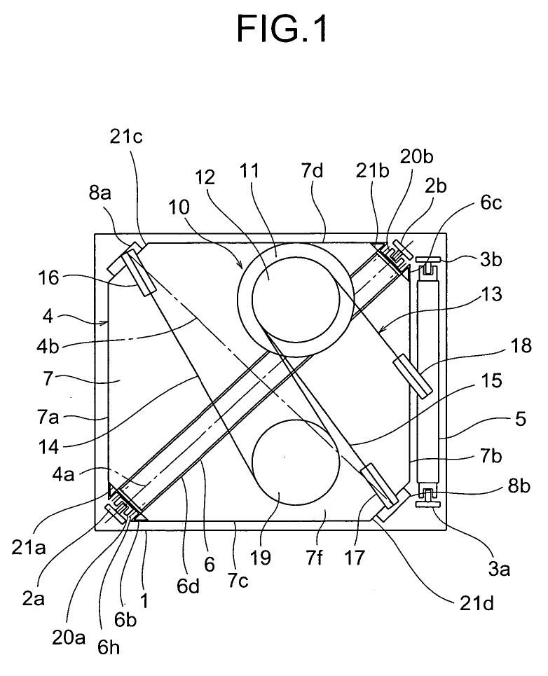

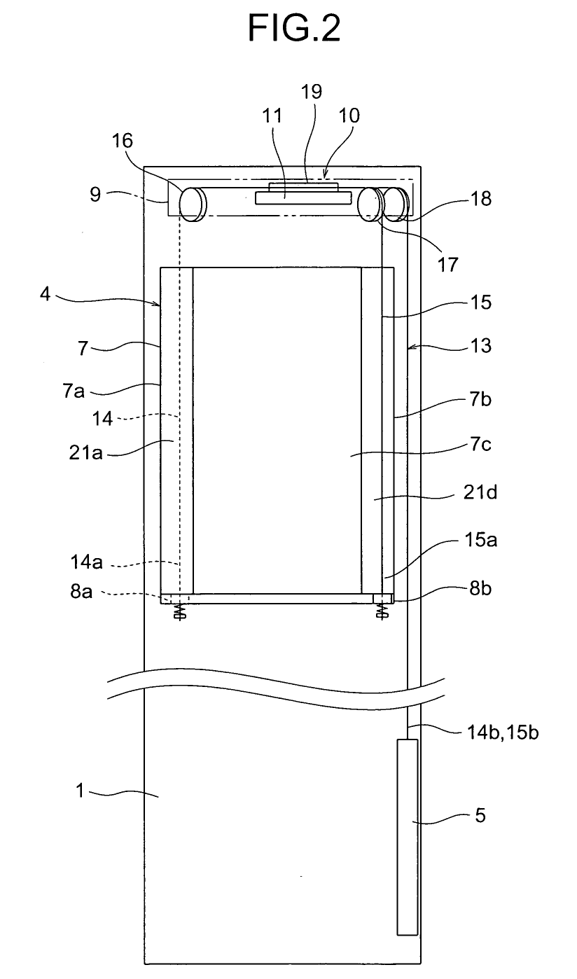

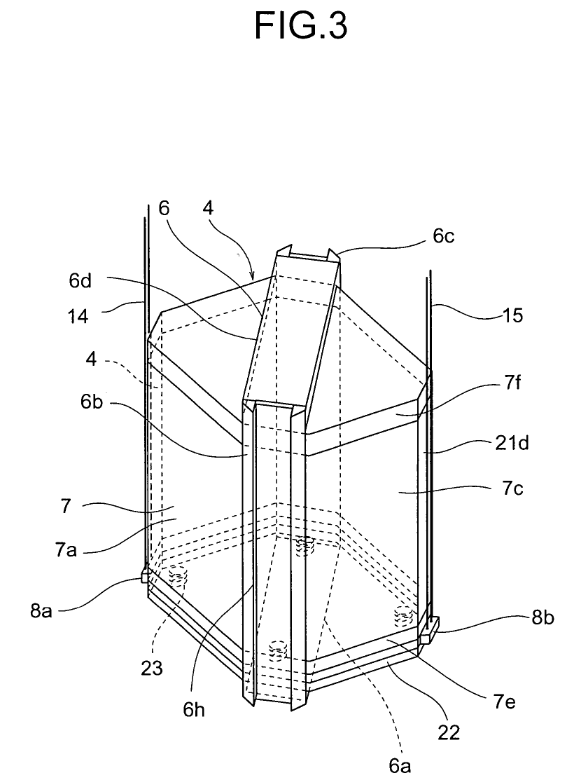

FIG. 1 is a plan view showing an elevator apparatus (machine room-less elevator) according to Embodiment 1 of the present invention, FIG. 2 is a side view showing the elevator apparatus shown in FIG. 1, and FIG. 3 is a perspective view showing a car shown in FIG. 1.

Referring to the figures, first and second car guide rails 2a, 2b and first and second counterweight guide rails 3a, 3b are disposed within a hoistway 1(in FIG. 2, the guide rails 2a, 2b, 3a, 3b are omitted). Each of the guide rails 2a, 2b, 3a, 3b has a T-shaped cross-section. The car guide rails 2a, 2b are opposed to each other.

A car 4 is raised and lowered within the hoistway 1 while being guided by the car guide rails 2a, 2b. As seen in the vertical projection plane, the car guide rails 2a, 2b are disposed on the extension of a first diagonal line 4a of the car 4. A counterweight 5 is raised and lowered within the hoistway 1 while being guided by the counterweight guide rails 3a, 3b.

First and second rope connecting portions 8a, 8b are provided in a lower portion of the car 4. As seen in the vertical projection plane, the rope connecting portions 8a, 8b are disposed on a second diagonal line 4b of the car 4.

A support frame 9 (FIG. 2) is disposed in an upper portion of the hoistway 1. The support frame 9 is at least partially supported by the car guide rails 2a, 2b and the counterweight guide rails 3a, 3b. Alternatively, the support frame 9 may be supported by a support portion provided to a building.

The support frame 9 supports a drive device (hoisting machine) 10 that generates a driving force for raising and lowering the car 4 and the counterweight 5. The drive device 10 has a drive device main body 11 including a motor and a brake, and a drive sheave 12 rotated by the drive device main body 11.

In this example, the drive sheave 12 is arranged on the drive device main body 11. Further, the drive sheave 12 is directly driven by the motor of the drive device main body 11 without the intervention of a decelerating mechanism.

Further, the drive device 10 is disposed horizontally (or substantially horizontally) such that a rotary shaft of the drive sheave 12 extends vertically (or substantially vertically) Employed as the drive device 10 is a thin hoisting machine having an axial dimension that is smaller than an outer diameter dimension in a direction perpendicular to the axial direction.

Moreover, the drive device 10 entirely or substantially entirely overlaps the car 4 as seen in the vertical projection plane. In other words, the drive device 10 is disposed directly above the car 4.

A main rope group 13 for suspending the car 4 and the counterweight 5 within the hoistway 1 is wound around the drive sheave 12. The main rope group 13 includes a plurality of first main ropes 14 (only one of which is shown in FIGS. 1 and 2) and a plurality of second main ropes 15 (only one of which is shown in FIGS. 1 and 2).

The car 4 and the counterweight 5 are suspended according to a 1:1 roping method by means of the main rope group 13.

Each first main rope 14 has a first end portion 14a connected to the first rope connecting portion 8a, and a second end portion 14b connected to an upper portion of the counterweight 5. Each second main rope 15 has a third end portion 15a connected to the second rope connecting portion 8b, and a fourth end portion 15b connected to the upper portion of the counterweight 5.

A first pulley 16 for guiding the first main rope 14 to the first rope connecting portion 8a, a second pulley 17 for guiding the second main rope 15 to the second rope connecting portion 8b, a third pulley 18 for guiding the first and second main ropes 14, 15 to the counterweight 5, and a deflection pulley 19 for guiding the first main rope 14 extending from the drive sheave 12 to the first pulley 16 are mounted on the support frame 9.

The first pulley 16 is disposed directly above the first rope connecting portion 8a. The second pulley 17 is disposed directly above the second rope connecting portion 8b.

The first to third pulleys 16 to 18 are disposed such that their respective rotary shafts extend horizontally. The deflection pulley 19 is disposed such that its rotary shaft extends vertically (or substantially vertically). Further, the deflection pulley 19 is disposed at the same position as the drive sheave 12 with respect to the depth direction of the car 4 (the right-to-left direction in FIG. 1).

The drive device 10 and the pulleys 16 to 19 are mounted on the common support frame 9 and unitized.

The car 4 has a car frame 6 (omitted in FIG. 2), a car floor platform 22 (FIG. 3) supported on the car frame 6, a cage 7 supported on the car floor platform 22, and a plurality of rubber cushions 23 (FIG. 3) interposed between the car floor platform 22 and the cage 7.

The wall portion of the cage 7 has a front face 7a provided with a car entrance (not shown), a back face 7b opposed to the front face, a first side face 7c, a second side face 7d opposed to the first side face 7c, a car floor 7e, and a ceiling portion 7f.

As seen in the vertical projection plane, the first diagonal line 4a is a straight line connecting the corner portion between the front face 7a and the first side face 7c to the corner portion between the back face 7b and the second side face 7d. The second diagonal line 4b is a straight line connecting a corner portion between the back face 7b and the first side face 7c to a corner portion between the front face 7a and the second side face 7d.

The counterweight 5 is disposed behind the car 4 so as to be opposed to the back face 6b when located at the same height as the car 4.

A first chamfered portion 21a is provided at the corner portion between the front face 7a and first side face 7c of the cage 7. A second chamfered portion 21b is provided at the corner portion between the back face 7b and second side face 7d of the cage 7. A third chamfered portion 21c is provided at the corner portion between the front face 7a and second side face 7d of the cage 7. A fourth chamfered portion 21d is provided at the corner portion between the back face 7b and first side face 7c of the cage 7.

The chamfered portions 21a to 21d are formed as so to chamfer the four corners of the rectangular cage 6 as seen in the vertical projection plane. In other words, the chamfered portions 21a to 21d can also be referred to as notched corner portions, or notched cross-section portions. The first chamfered portion 21a and the second chamfered portion 21b are parallel or substantially parallel to each other. The third chamfered portion 21c and the fourth chamfered portion 21d are parallel or substantially parallel to each other.

The chamfered portions 21a to 21d are continuously provided along the raising and lowering direction (vertical direction) of the car 4. Although the floor surface area of the cage 7 slightly decreases due to the provision of the chamfered portions 21a, 21b, such a decrease in floor surface area is not so large as to affect the passenger capacity of the elevator.

As seen in the vertical projection plane, the first and second rope connecting portions 8a, 8b are disposed so as to protrude from the third and fourth chamfered portions 21c, 21d, respectively. As a result, the first main rope 14 is disposed so as to be partially opposed to the third chamfered portion 21c. Further, the second main rope 15 is disposed so as to be partially opposed to the fourth chamfered portion 21d.

The car frame 6 has a horizontal lower beam 6a supporting the car floor platform 22, vertical first and second vertical columns 6b, 6c that are parallel to each other, and a horizontal upper beam 6d disposed between respective lower end portions of the vertical columns 6b, 6c. The lower beam 6a is disposed between the vertical columns 6b, 6c. The lower beam 6a is disposed between the vertical columns 6b, 6c. The first and second rope connecting portions 8a, 8b are fixed to the car floor platform 22.

As seen in the vertical projection plane, the lower beam 6a and the upper beam 6d are disposed along the first diagonal line 4a of the car 4. The vertical columns 6b, 6c are disposed along the first and second chamfered portions 21a, 21b. That is, the vertical columns 6b, 6c are disposed in spaces adjacent to the chamfered portions 2la, 21b, respectively. Further, the back faces of the vertical columns 6b, 6c are bonded to the first and second chamfered portions 21a, 21b, respectively. Further, the cage 7 is fixed to the vertical columns 6b, 6c at the first and second chamfered portions 21a, 21b, respectively, by means of fastening members such as bolts.

The vertical columns 6b, 6c are opposed to the car guide rails 2a, 2b, respectively. A groove portion (recess) 6h that extends continuously in the vertical direction is formed in each of the faces of the vertical columns 6b, 6c opposed to the car guide rails 2a, 2b, respectively. Conversely stated, the car guide rails 2a, 2b are each disposed so as to face the groove portion 6h.

At least a part of a first guide shoe 20a that engages with the first car guide rail 2a is disposed within the groove portion 6h of the first vertical column 6b. At least a part of a second guide shoe 20b that engages with the second car guide rail 2b is disposed within the groove portion 6h of the second vertical column 6c. In this example, the entire car guide shoes 20a, 20b are each received within the groove portion 6h.

As the car guide shoes 20a, 20b, there can be used, for example, sliding guide shoes or roller guide shoes.

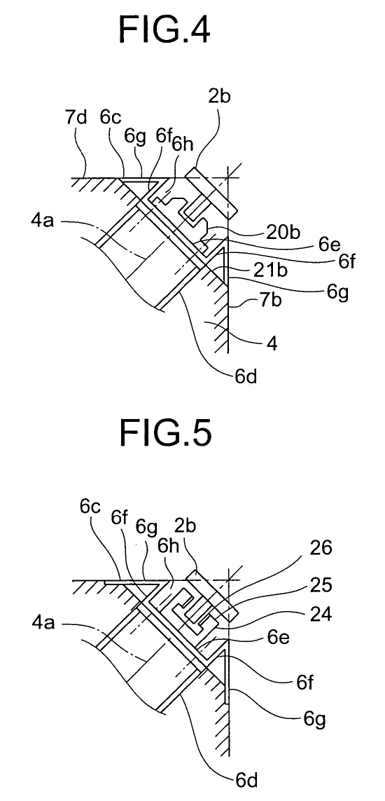

FIG. 4 is an enlarged main-portion plan view of FIG. 1. As shown in FIG. 4, as seen in the vertical projection plane, the vertical column 6c and the second car guide shoe 20b are disposed inside a triangular region (vertical-column installing region) surrounded by a straight line obtained by extending the back face 7b, a straight line obtained by extending the second side face 7d, and a surface of the second chamfered portion 21b. Likewise, as seen in the vertical projection plane, the vertical column 6b and the first car guide shoe 20a are disposed inside a triangular region (vertical-column installing region) surrounded by a straight line obtained by extending the front face 7a, a straight line obtained by extending the first side face 7c, and a surface of the first chamfered portion 21a.

It is desirable that the car guide shoes 20a, 20b be so disposed as to be accommodated in the groove portion 6h of the vertical columns 6b, 6c, respectively, by 80% or more as seen in their cross-sections.

Further, as seen in the vertical projection plane, the car guide rails 2a, 2b are at least partially disposed in the groove portion 6h of the vertical columns 6b, 6c, respectively.

The vertical columns 6b, 6c each have a first part 6e respectively bonded to the chamfered portions 21a, 21b, a pair of second parts 6f extending at a right angle to the first part 6e from the opposite end portions of the first part 6e, and a pair of third parts 6g respectively extending from the distal ends of the second parts 6f toward the chamfered portions 21a, 21. The first to third parts 6e to 6g are each formed by bending a steel plate. By adopting such a bending structure, the strength of the vertical columns 6b, 6c against toppling, twisting, and bending is enhanced.

The groove portion 6h is formed by the first part 6e and the second part 6f. The car guide shoes 20a, 20b are each attached to the first part 6e. The third part 6g is flush with the side face (the front face 7a, the back face 7b, the first side face 7c, or the second side face 7d) of the cage 7 adjacent thereto.

Further, as shown in FIG. 5, as seen in the vertical projection plane, at least a part of a safety device 24 for bringing the car 4 to an emergency stop protrudes from each of the chamfered portions 21a, 21b to be disposed within the groove portion 6h of each of the vertical columns 6b, 6c, respectively. In this example, the entire engaging portion of the safety device 24 with each of the car guide rails 2a, 2b is received within the groove portion 6h.

The safety device 24 may be a mechanical device operating through the transmission of a mechanical operating force or an electric device having an actuator that operates in response to an electric actuation signal.

The safety device 24 has a fixed portion 25 fixed to the car 4 side, and a braking member (wedge member) 26 provided slidably on the inner side of the fixed portion 25. When the safety device 24 is actuated, the braking member 26 is displaced upwards with respect to the car 4 along the slide/guide surface of the fixed portion 25. As a result, the braking member 26 is wedged in between the slide/guide surface and a side face of each of the car guide rails 2a, 2b, so the car guide rails 2a, 2b are each pinched between the fixed portion 25 and the braking member 26 to thereby bring the car 4 to an emergency stop.

Further, as shown in FIG. 5, the third part 6g of each of the vertical columns 6b, 6c may be bonded and fixed to the front face 7a or the back face 7b and to the first side face 7c or the second side face 7d.

In the elevator apparatus as described above, the vertical columns 6b, 6c are disposed in the chamfered portions 2la, 21b provided at the corner portions of the cage 7, so the vertical columns 6b, 6c do not protrude from the side faces 7c, 7d of the cage 7, respectively. Accordingly, it is possible to achieve a reduction in the installation space for the elevator apparatus in the width direction of the car 4, thereby enabling a further reduction in hoistway space.

The hoistway space can be more effectively reduced particularly when the reduction in the horizontal cross-sectional area of the hoistway 1 due to the provision of the chamfered portions 21a, 21b is larger than the reduction in the horizontal cross-sectional area of the cage 7 due to the provision of the chamfered portions 21a, 21b.

Further, in the case where elevator apparatuses are arranged in parallel, it is possible to minimize the distance between the cars of the adjacent elevator apparatuses, thereby enabling an effective reduction in the hoistway space as a whole.

Further, the car guide shoes 20a, 20b and the car guide rails 2a, 2b are disposed within the groove portions 6h of the vertical columns 6b, 6c, respectively, thereby enabling a further reduction in the hoistway space.

Furthermore, as seen in the vertical projection plane, at least a part of the safety device 24 is disposed within the groove portion 6h of each of the vertical columns 6b, 6c, thereby making it possible to prevent the safety device 24 from protruding from the car 4. This enables a reduction in the installation space for the elevator apparatus in the width direction of the car 4 and hence a further reduction in the hoistway space.

Further, the chamfered portions 21a to 21d are provided at the four corners of the cage 7, respectively. Accordingly, when the car 4 and the counterweight 5 pass each other within the narrow hoistway 1, air can be released through the spaces formed by the chamfered portions 21a to 21d, thereby making it possible to prevent an impact sound or vibration from being generated as the car 4 and the counterweight 5 pass each other.

Further, as seen in the vertical projection plane, the rope connecting portions 8a, 8b protrude from the chamfered portions 21c, 21d, respectively, so it is possible to achieve a further reduction in the installation space for the elevator apparatus in the width direction of the car 4, thereby enabling a further reduction in the hoistway space.

It should be noted that while in the above-described example the surfaces of the chamfered portions 21a to 21d are flat, they may also be curved.

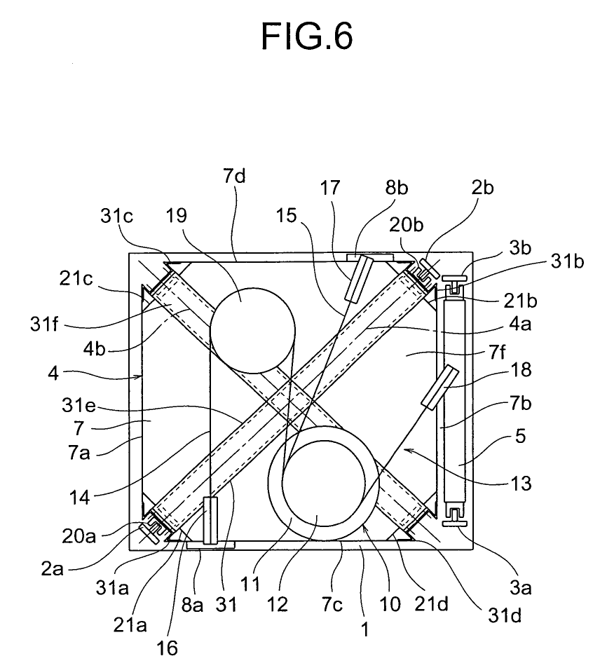

Further, while the first to fourth chamfered portions 21a to 21d are provided in the above-described example, there may be provided only the first and second chamfered portions 21a, 21b. In this case, as shown in FIG. 6, for example, the rope connecting portions 8a, 8b may be disposed so as to protrude slightly from the side faces 7c, 7d of the cage 7, respectively.

### Embodiment 2

Next, FIG. 6 is a plan view showing an elevator apparatus according to Embodiment 2 of the present invention. Referring to FIG. 6, a car 4 has a car frame 31 and a cage 7 supported on the car frame 31.

The car frame 31 has first and second lower beams (not shown) extending horizontally and supporting the cage 7, first to fourth vertical columns 31a to 31d that are parallel to each other, a first horizontal upper beam 31e disposed between the upper end portions of the vertical columns 31a, 31b, and a second horizontal upper beam 31f disposed between the upper end portions of the vertical columns 31c, 31d. The first lower beam is disposed between the lower end portions of the vertical columns 31a, 31bc. The second lower beam is disposed between the lower end portions of the vertical columns 31c, 31d.

As seen in the vertical projection plane, the first lower beam and the first upper beam 31e are disposed along the first diagonal line 4a of the car 4. As seen in the vertical projection plane, the second lower beam and the second upper beam 31f are disposed along the second diagonal line 4b of the car 4. That is, the first lower beam and the second lower beam cross each other in a lower portion of the cage 7. Further, the first upper beam 31e and the second upper beam 31f cross each other above the cage 7.

The vertical columns 31a, 31b are disposed along the first and second chamfered portions 21a, 21b, respectively. That is, the vertical columns 31a, 31b are disposed in spaces adjacent to the chamfered portions 21a, 21b, respectively. Further, the back surfaces of the vertical columns 31a, 31b are bonded to the first and second chamfered portions 21a, 21b, respectively. Further, the cage 7 is fixed to the vertical columns 31a, 31b at the first and second chamfered portions 21a, 21d, respectively, by means of fastening members such as bolts.

The vertical columns 31c, 31d are disposed along the third and fourth chamfered portions 21c, 21d, respectively. That is, the vertical columns 31c, 31d are disposed in spaces adjacent to the chamfered portions 21c, 21d, respectively. Further, the back surfaces of the vertical columns 31c, 31d are bonded to the third and fourth chamfered portions 21c, 21d, respectively. Further, the cage 7 is fixed to the vertical columns 31c, 31d at the third and fourth chamfered portions 21c, 21d, respectively, by means of fastening members such as bolts.

As seen in the vertical projection plane, the first and second rope connecting portions 8a, 8b protrude outwards from the first and second side faces 7c, 7d, respectively, in the width direction of the car 4. Otherwise, Embodiment 2 is of the same construction as Embodiment 1.

In the elevator apparatus as described above, the vertical columns 31a to 31d are disposed at the four corners of the car 4, thereby making it possible to enhance the strength of the car frame 31. Further, the first lower beam and the second lower beam cross each other, and the first upper beam 31e and the second upper beam 31f cross each other, thereby making it possible to further enhance the strength of the car frame 31.

It should be noted that as in Embodiment 1, the rope connecting portions 8a, 8b can be disposed so as to protrude from the chamfered portions 21c, 21d, respectively.

### Embodiment 3

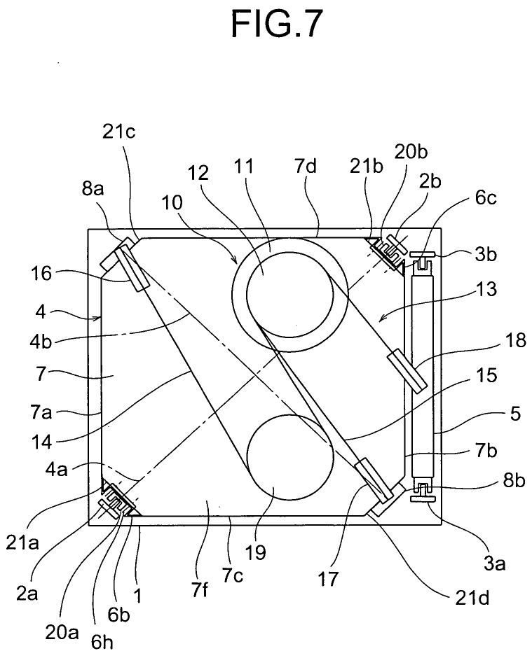

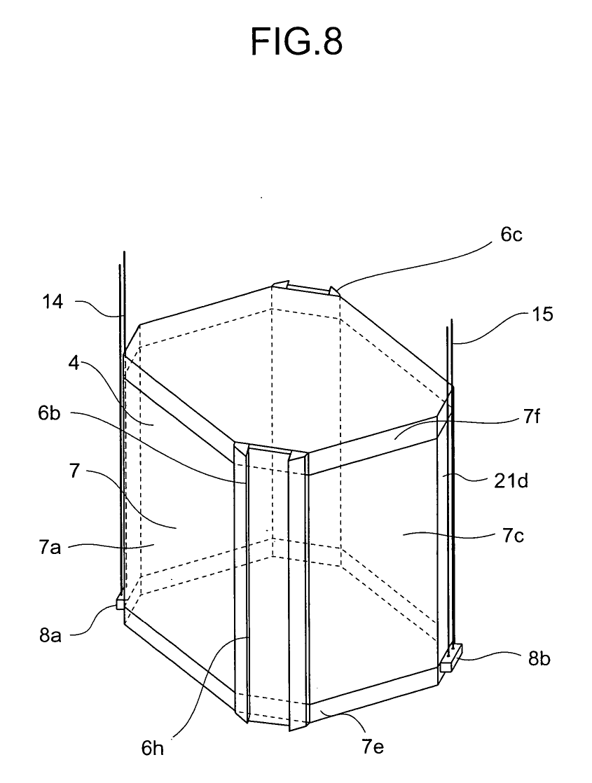

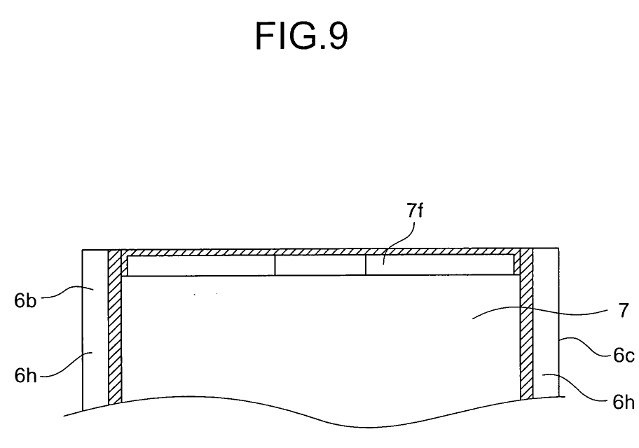

Next, FIG. 7 is a plan view showing an elevator apparatus according to Embodiment 3 of the present invention, FIG. 8 is a perspective view showing a car shown in FIG. 7, and FIG. 9 is a main-portion sectional view of the car shown in FIG. 7. In this example, the rigidity of the ceiling portion 7f of the cage 7 is enhanced to thereby omit the upper beam, the rigidity of the car floor 7e is enhanced to thereby omit the lower beam. In other words, the ceiling portion 7f and the car floor 7e each serve as a part of the car frame. Otherwise, Embodiment 3 is of the same construction as Embodiment 1.

According to the elevator apparatus as described above, the upper beam and the lower beam are omitted, whereby the vertical dimension of the car 4 can be reduced to thereby achieve a reduction in the vertical dimension of the hoistway 1.

### Embodiment 4

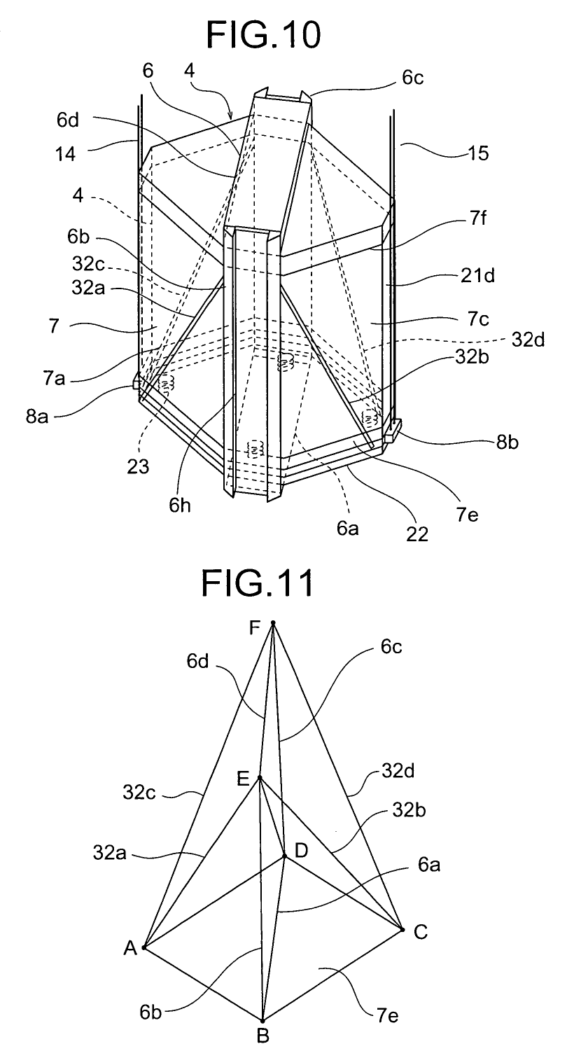

Next, FIG. 10 is a perspective view showing a car of an elevator apparatus according to Embodiment 4 of the present invention. Referring to FIG. 10, first to fourth reinforcing members (diagonal braces) 32a to 32d are provided between the car floor platform 22 and each of the vertical columns 6b, 6c. Otherwise, Embodiment 4 is of the same construction as Embodiment 1.

FIG. 11 is an explanatory diagram schematically showing the structure of the car frame 6 shown in FIG. 10. By providing the reinforcing members 32a to 32d, intersection points E, F between the upper beam 6d and the vertical columns 6b, 6c, respectively, and points A, B, C, D at the four corners of the car floor platform 22 are substantially connected to each other through the reinforcing members 32a to 32d, thereby enhancing the strength of the car frame 6. That is, all the strength members excluding the car floor platform 22 form triangular strength spaces (ΔEAB, ΔEBC, ΔEFA, ΔECF, ΔFCD, ΔFDA), thus constituting a heptahedron formed by the points A to F. Accordingly, a high-strength structural body can be constructed despite the simple structure.

### Embodiment 5

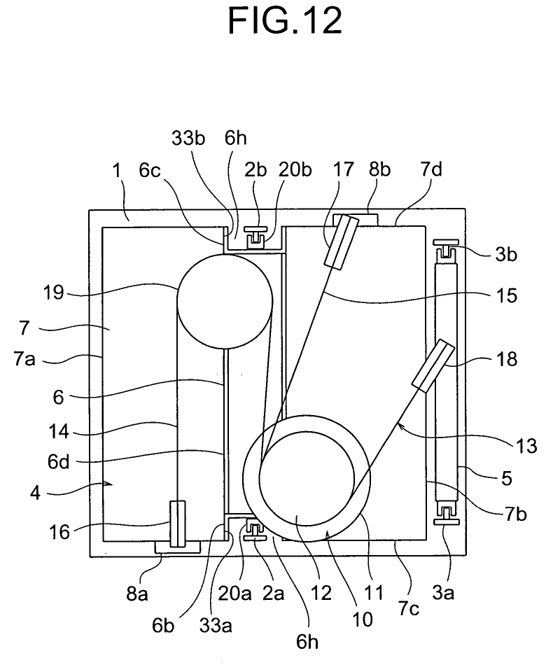

Next, FIG. 12 is a plan view showing an elevator apparatus according to Embodiment 5 of the present invention. Referring to FIG. 12, first and second recesses 33a, 33b are provided in the side faces 7c, 7d of the cage 7, respectively. The first and second recesses 33a, 33b are provided continuously along the raising and lowering direction (vertical direction) of the car 4. That is, the first and second recesses 33a, 33b are formed in a groove-like fashion.

Slight protrusions are formed inside the car 6 due to the provision of the first and second recesses 33a, 33b. However, those protrusions are not so large as to affect the passenger capacity.

The vertical columns 6b, 6c are at least partially disposed within the recesses 33a, 33b, respectively. In this example, the entire vertical columns 6b, 6c are disposed within the recesses 33a, 33b, respectively. The car guide shoes 20a, 20b are at least partially received within the groove portions 6h of the vertical columns 6b, 6c, respectively. In this example, the car guide shoes 20a, 20b are each entirely received within the groove portion 6h. Further, in this example, the car guide rails 2a, 2b are each also entirely received within the groove portion 6h.

The first and second recesses 33a, 33b are provided at the same position in the depth direction of the cage 6. Accordingly, the vertical columns 6b, 6c are also provided at the same position in the depth direction of the cage 6. As a result, the upper beam 6d and lower beam (not shown) of the car frame 6 are disposed in parallel to each other in the width direction of the car 4.

As seen in the vertical projection plane, the first and second rope connecting portions 8a, 8b protrude from the first side face 6c and the second side face 6d, respectively. Further, as seen in the vertical projection plane, the first and second rope connecting portions 8a, 8b are disposed at symmetrical or substantially symmetrical positions with respect to the center of gravity of the car 4.

Further, the first rope connecting portion 8a is disposed forward of the first car guide rail 2a with respect to the depth direction of the car 4. The second rope connecting portion 8b is disposed rearward of the second car guide rail 2b with respect to the depth direction of the car 4.

In Embodiment 1, the vertical columns 6b, 6c are respectively disposed along the chamfered portions 21a, 21b provided at the corner portions of the cage 7. However, also by providing the recesses 33a, 33b in the side faces 7c, 7d of the cage 7 and disposing the vertical columns 6b, 6c within the recesses 33a, 33b, the installation space for the elevator apparatus in the width direction of the car 4 can be reduced without the vertical columns 6b, 6c protruding from the side faces 7c, 7b of the cage 7, respectively, thereby enabling a further reduction in the hoistway space.

While in Embodiment 5 the recesses 33a, 33b are provided at the same position in the depth direction of the car 4, the recesses 33a, 33b may be provided in a longitudinally staggered arrangement.

Further, instead of the chamfered portions as described in Embodiment 1, the recesses as described in Embodiment 5 may be provided at the corner portions of the cage, with the vertical columns being received within those recesses.

Further, while in the above-described examples there are provided the two rope connecting portions 8a, 8b that are separate from each other, there may be provided only one connecting portion. Further, the rope connecting portions may be provided in the upper beam, for example.

Furthermore, while the above-described examples are directed to the elevator apparatus of the 1:1 roping system, the roping system is not limited to this. For example, the present invention is also applicable to an elevator apparatus of a 2:1 roping system.

Further, the counterweight may be disposed by the side of the car so that the counterweight is opposed to one side face of the car when located at the same height as the car.

Further, in the above-mentioned examples, the machine-room-less elevator apparatus having the drive device disposed within the hoistway is described. However, the present invention is also applicable to an elevator apparatus having a machine room in which a drive device and a control panel are installed.

Furthermore, in the aforementioned examples, the drive device is disposed such that the rotary shaft of the drive sheave extends vertically or almost vertically. However, the disposition of the drive device is not limited to this. For example, the drive device maybe disposed such that the rotary shaft of the drive sheave extends horizontally.

Further, in the above-mentioned examples, the drive device is disposed such that the drive sheave is located in the upper portion of the drive device main body. Conversely, however, the drive device may also be disposed such that the drive sheave is located in the lower portion of the drive device main body.

Furthermore, in the above-mentioned examples, the drive device is disposed in the upper portion of the hoistway. However, the position of the drive device is not limited to this. For example, the drive device may also be disposed in the lower portion of the hoistway. Further, the present invention is also applicable to a self-propelled elevator apparatus having a drive device mounted in an upper or lower portion of a car.

Furthermore, for example, ropes having a circular cross-section, belt-like ropes, or the like can be employed as the main ropes.

Further, for example, steel ropes, resin-coated ropes having an outer layer coating member made of a high-friction resin material provided on an outer periphery portion thereof, or the like can be employed as the main ropes. The use of resin-coated ropes makes it possible to ensure a large traction force at a small winding angle. Further, the resin-coated ropes can enhance flexibility more than simple steel ropes and the diameter of the drive sheave can thus be reduced.

In addition, the components (drive device, return pulley, deflection pulley, and the like) disposed in the upper portion of the hoistway 1 may be unitized by being mounted on a common support frame.

Furthermore, the present invention is applicable to various elevator apparatuses such as an elevator of a one-shaft-multi-car elevator system and a double-deck elevator.

1. An elevator apparatus comprising a car raised and lowered within a hoistway, the car having a car frame and a cage supported on the car frame, wherein:
the cage has a chamfered portion provided at a corner portion of the cage; and
the car frame has a vertical column arranged along the chamfered portion.

2. The elevator apparatus according to claim 1, wherein:
the chamfered portion comprises a first chamfered portion and a second chamfered portion which are located at diagonal positions of the cage; and
the vertical column comprises a first vertical column disposed along the first chamfered portion, and a second vertical column disposed along the second chamfered portion.

3. The elevator apparatus according to claim 2, further comprising a first car guide rail and a second car guide rail for guiding raising and lowering of the car, the first car guide rail and the second car guide rail being disposed within the hoistway in opposition to the first vertical column and the second vertical column, respectively.

4. The elevator apparatus according to claim 3, wherein the first vertical column and the second vertical column have attached thereto a first car guide shoe and a second car guide shoe which engage with the first car guide rail and the second car guide rail, respectively.

5. The elevator apparatus according to claim 3, wherein:
the first vertical column and the second vertical column each have a groove portion, which extends continuously in a vertical direction, formed in each of faces of the first vertical column and the second vertical column opposed to the first guide rail and the second guide rail, respectively; and
a first car guide shoe and a second car guide shoe, which respectively engage with the first car guide rail and the second car guide rail, are each at least partially disposed within the groove portion.

6. The elevator apparatus according to claim 3, wherein:
the first vertical column and the second vertical column each have a groove portion, which extends continuously in a vertical direction, formed in each of faces of the first vertical column and the second vertical column opposed to the first guide rail and the second guide rail, respectively; and
the first car guide rail and the second car guide rail are each at least partially disposed within the groove portion.

7. The elevator apparatus according to claim 3, further comprising a safety device mounted on the car and coming into engagement with the first car guide rail and the second car guide rail to bring the car into an emergency stop, wherein:
the first vertical column and the second vertical column each have a groove portion formed in each of faces of the first vertical column and the second vertical column opposed to the first car guide rail and the second car guide rail, respectively; and
the safety device is at least partially disposed within the groove portion as seen in a vertical projection plane.

8. The elevator apparatus according to claim 2, wherein the car frame is disposed between upper end portions of the first vertical column and the second vertical column, and has an upper beam that is disposed along a diagonal line of the car as seen in a vertical projection plane.

9. The elevator apparatus according to claim 2, wherein the car frame is disposed between lower end portions of the first vertical column and the second vertical column, and has a lower beam that is disposed along a diagonal line of the car as seen in a vertical projection plane.

10. The elevator apparatus according to claim 1, wherein:
the chamfered portion comprises a first chamfered portion and a second chamfered portion which are located at positions on one diagonal of the cage, and a third chamfered portion and a fourth chamfered portion which are located at positions on the other diagonal of the cage; and
the vertical column comprises a first vertical column, a second vertical column, a third vertical column, and a fourth vertical column which are disposed along the first chamfered portion, the second chamferedportion, the third chamfered portion, and the fourth chamfered portion, respectively.

11. The elevator apparatus according to claim 10, wherein the car frame comprises a first upper beam disposed between upper end portions of the first vertical column and the second vertical column, and a second upper beam crossing the first upper beam and disposed between upper end portions of the third vertical column and the fourth vertical column.

12. The elevator apparatus according to claim 10, wherein the car frame comprises a first lower beam disposed between lower end portions of the first vertical column and the second vertical column, and a second lower beam crossing the first lower beam and disposed between lower end portions of the third vertical column and the fourth vertical column.

13. An elevator apparatus comprising a car raised and lowered within a hoistway, the car having: a car frame including a vertical column; and a cage supported on the car frame, wherein:
the cage has a recess provided in a side face thereof; and
the vertical column is at least partially disposed within the recess.
